(19) United States
(12) Patent Application Publication
(10) Pub. No.: US 2016/0020059 A1
(43) Pub. Date: Jan. 21, 2016

(54) COOLING ARRANGEMENT FOR X-RAY GENERATOR

(71) Applicants: Stephan HAFERL, Granges-Paccot, Fribourg (CH); Iris SCHMID, Liebefeld (CH); Matt PRICE, Neyruz (CH)

(72) Inventors: Stephan HAFERL, Granges-Paccot, Fribourg (CH); Iris SCHMID, Liebefeld (CH); Matt PRICE, Neyruz (CH)

(73) Assignee: COMET HOLDING AG, Flamatt (CH)

(21) Appl. No.: 14/414,095

(22) PCT Filed: Jul. 11, 2012
(86) PCT No.: PCT/EP2012/063589

§ 371 Date: Apr. 16, 2015

(51) Int. Cl. H01J 35/06; H01J 29/00

(52) U.S. Cl. CPC H01J 35/06; H01J 29/006; H01J 2235/1262; H01J 2235/1212; H01J 2229/0069

(57) ABSTRACT

In a device for generating X-rays or electron beams the cathode of the device is mounted on a ceramic insulator which becomes hot during operation, and the ceramic insulator is cooled by a fluid coolant flowing around the outside of the insulator at the remote end of the insulator, away from the cathode. The coolant conduit can be formed by flange rings, soldered directly on to the surface of the insulator, and the conduit may be shaped such that the coolant is in direct contact with the insulator. A method for manufacturing the de ice is also described.

### BACKGROUND AND SUMMARY

The present invention relates to the cooling of X-ray or E-beam generators. In particular, but not exclusively, the invention relates to vacuum-tube type devices having a ceramic or other high-voltage electrical insulator which is cooled by means of a fluid coolant circuit.

Vacuum X-ray or E-beam generator devices comprise components which generate large quantities of heat during operation, and this heat must be removed in order for the device to continue to function. However, such devices also require a high vacuum in order to function efficiently, and it is undesirable to introduce cooling circuits into the vacuum chamber itself in order to cool the components which are operating inside the vacuum (for example the cathode assembly of an X-ray tube).

It has been proposed in international application WO2009/083534 to dissipate heat from the cathode of an X-ray tube by cooling the ceramic insulator on which the cathode assembly is mounted. An omega-shaped copper yoke is arranged around the outer surface of the insulator and tightened. The yoke acts as a heat-sink for cooling the outer surface of the insulator. The mode coolant tubes pass perpendicularly through the copper, so that beat from the copper yoke is conveyed away by the anode coolant passing through the tubes.

In the prior art cooling arrangement described above, the yoke must he secured tightly around the insulator in order to ensure a good thermal contact between the copper of the yoke and the outer surface of the insulator. This tightness can however lead to a build-up of potentially damaging mechanical stresses as the insulator warms up and expands during operation. A copper mesh or felt can be placed between the yoke and the insulator in order to enhance thermal conductivity while allowing a certain margin for expansion and contraction. The prior art arrangement also suffers from the disadvantage that the omega-shaped yoke occupies a significant volume at the end of the insulator. Since the yoke must be fitted outside the vacuum chamber, it also follows that the cooling effect of the yoke is spatially remote from the source of the heat (the cathode).

It is desirable to address some of the above and other problems with the prior art devices and methods.

Amongst other advantages of the device and method of aspects of the invention are one or more of the cooling efficiency is greatly increased, the cooling elements take up less space. the cooling elements are located closer to the source of heat to be dissipated, reduced stress on the insulator element, and/or the cooling elements can be incorporated into the existing construction of the vacuum housing.

The method offers a way of creating a cooling conduit which is thermally effective and which occupies little more space than that required for the vacuum enclosure seal, for example.

### BRIEF DESCRIPTION OF THE DRAWINGS

The invention and its advantages will become apparent in the following description, together with illustrations of example embodiments and implementations given in the accompanying drawings. The drawings are intended merely as illustrations of the present invention, and are not to be construed as limiting the scope of the invention.

FIG. 1 shows a first longitudinal sectional view an example of an X-ray generator device according to an embodiment of the invention.

FIG. 2 shows a transverse sectional view of the X-ray generator device depicted in FIG. 1.

FIG. 3 shows a second longitudinal sectional view of the X-ray generator device depicted in FIGS. 1 and 2.

FIG. 4 illustrates an enlarged view of a first cooling conduit arrangement for the device depicted in FIGS. 1 to 3.

FIG. 5 illustrates an enlarged view of a second cooling conduit arrangement for the device depicted in FIGS. 1 to 3.

FIG. 6 shows an adaptation of the device depicted in FIG. 5.

Where the same reference signs have been used in different drawings, these are intended to refer to the same or corresponding features.

### DETAILED DESCRIPTION

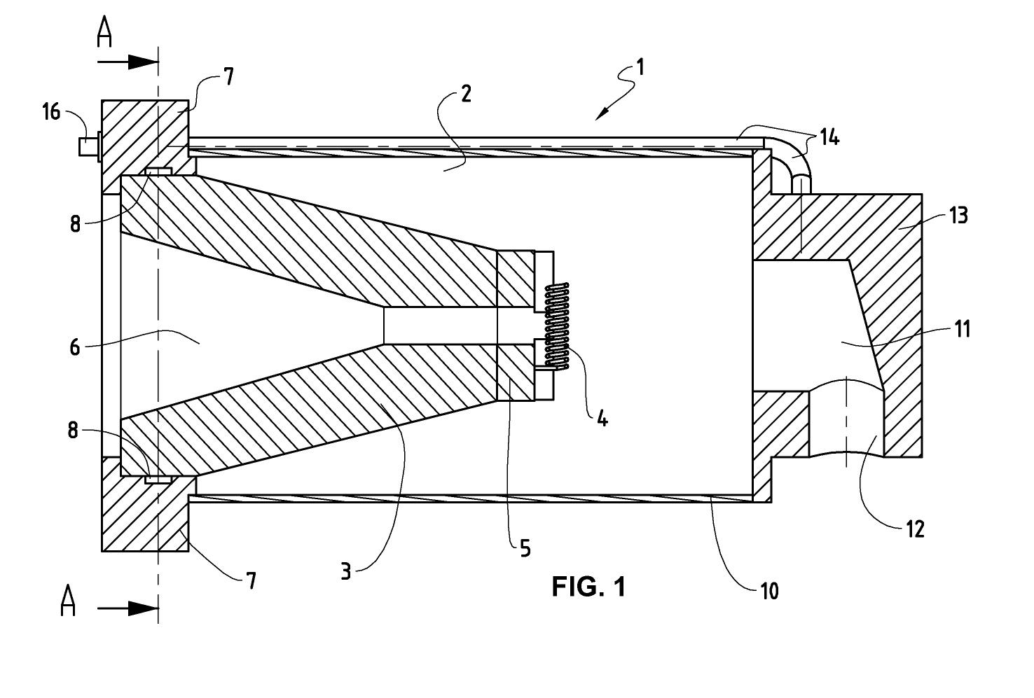

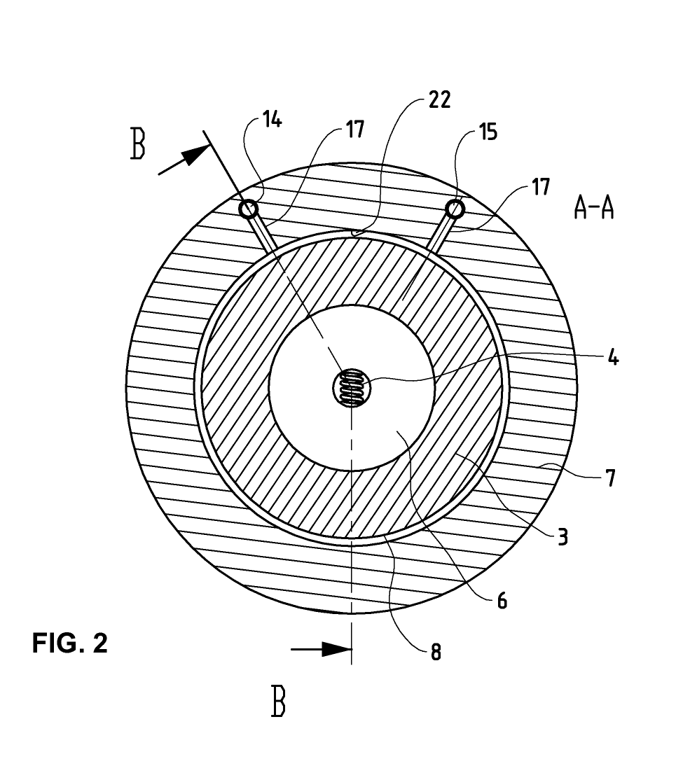

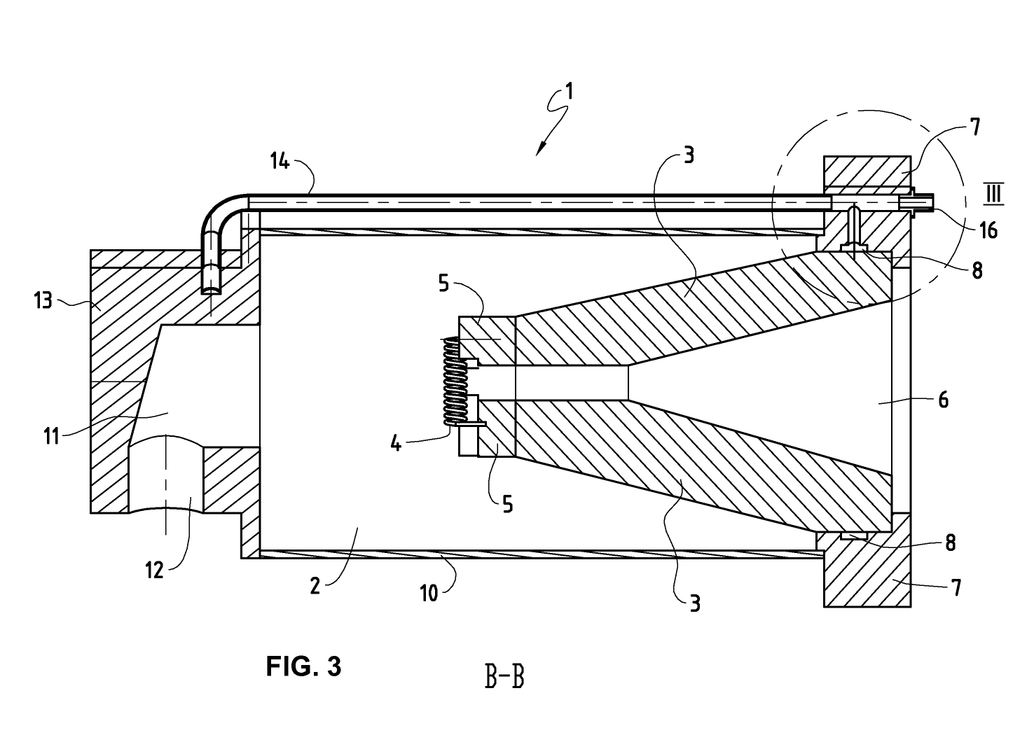

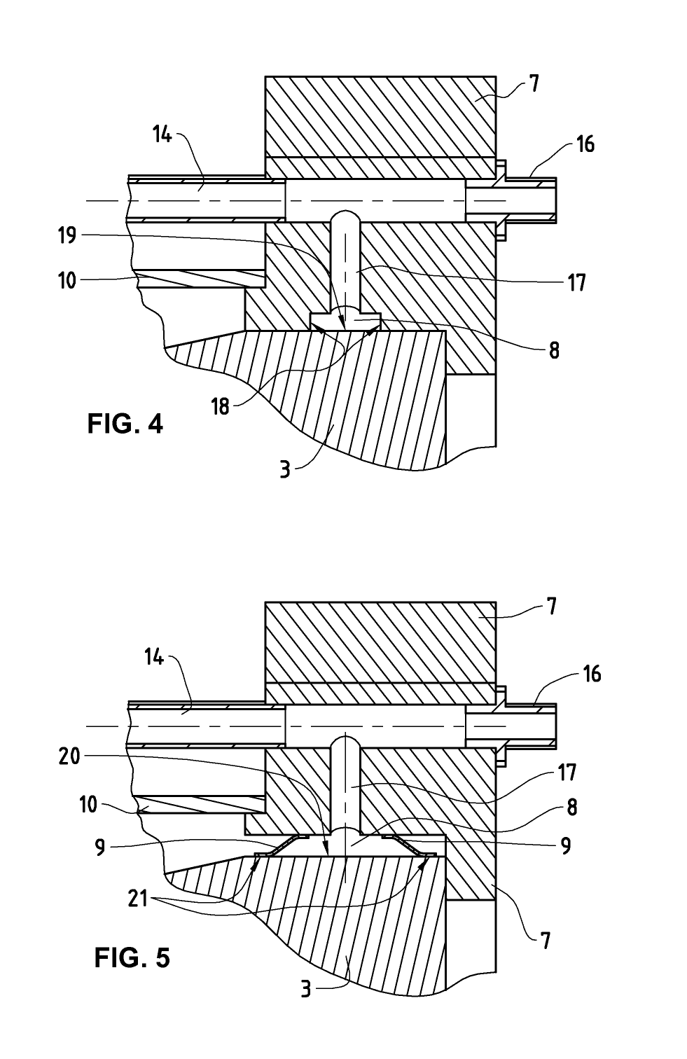

FIGS. 1,2 and 3 are schematic sectional representations of the same example X-ray tube which will be used as an example to illustrate the principles of the invention. FIG. 2 represents a planar sectional view along the section line A-A shown in FIG. 1, and FIG. 3 represents a discontinuous section taken through the section line B-B in FIG. 2. FIGS. 4, 5 and 6 show enlarged views of the region marked III in FIG. 3, and illustrate three variants of the cooling arrangement of the invention.

Referring now to FIG. 1, the X-ray tube 1 comprises a vacuum enclosure 10, which is formed essentially as a cylindrical wall 10, capped at one end by the anode assembly 12, 13, 14, and at the other end by a collar 7 which serves both to seal the end of the cylindrical wall 10 and to support the insulator 3 on which is mounted the cathode assembly 4, 5. The vacuum space inside the X-ray tube is indicated by the reference 2. The cathode assembly 4, 5 is not shown in detail, but simply represented by a symbol of a coil element 4, and a cathode support part 5. The anode assembly 11, 12, 13 is cooled by means of a coolant circuit supplied by coolant channel(s) 14, which convey coolant between an external fluid coolant connector 16 and the anode assembly 11, 12, 13. The anode assembly 11, 12, 13 may include an anode block 13 comprising anode block cooling circuit channels (not shown), for example integrated in the material of the block 13. The reference 11 indicates an anode region, where an anode-target may be mounted.

Reference 12 indicates an X-ray window where X-rays generated by electrons hitting the target (not shown) can exit the vacuum tube 1.

In the illustrated example, insulator element 3 is formed as a hollow cone having thick walls made of a ceramic material. The shape of the inner space inside the cone is designed to correspond to the shape of a high-voltage connector which can be connected to supply the high voltage required for accelerating elections emitted from the cathode towards the anode. Such connectors are generally covered with an elastic insulating material, such as a polymeric material, in order to ensure a close mechanical fit between the connector and the insulator, while still reducing the possibility of electrical discharge through the body of the connector.

Heat generated in the cathode is conducted away through the body of the insulator element 3, and it is important to ensure that this heat does not adversely affect the mechanical or insulating properties of the cover of the connector. The connector may be insulated with a thick polymeric insulator, for example, which may be damaged, or whose insulating properties may be adversely affected at high temperatures. For this reason, cooling is provided on or near the outer surface of the insulator 3, to draw heat away from the inner surface facing the connector (the polymer/ceramic interface, for example), and to reduce the temperature of the connector insulation during operation of the X-ray tube.

The cooling is achieved in this example by means of a coolant conduit 8 formed between the collar element 7 and the insulator element 3. In this simple example, the coolant conduit 8 is formed as a channel in the inner surface of the collar element 7. In other words, the walls of the coolant conduit are integral with the collar element 7. The collar element thus serves to provide not only the vacuum seal between the enclosure wall 10 and the insulator 3, but also some (in this case three) of the walls of the coolant conduit 8. The collar element 7 is tightly sealed to the insulator element 3 and to the vacuum wall in order to protect the high vacuum 2 inside the tube, and in order to retain the coolant within the coolant conduit 8.

The coolant conduit may alternatively be constructed as a yoke, in a similar manner to that described in prior art document WO2009/083534, except that the yoke is hollow, and the coolant flows through the hollow space within the yoke, circumferentially around the outside (the outer surface) of the insulator. The coolant conduit may also be constructed as a passage or tunnel through the insulator material itself, for example in a region near to the surface of the outer periphery of the insulator, at the region (referred to as the second region) of the insulator remote from the electron emitter. In this variant, the coolant can passing through the passage and take heat directly from contact with the insulator material.

In this specification, we describe the coolant as flowing in contact with the insulator, or with the material of the insulator. This description should be understood to include the possibility of any intermediate layer or coating which may in practice be present between the coolant fluid, and the insulator material itself.

Similarly, reference is made to ring-shaped elements and ring flange elements, and it should be understood that such elements are not limited, to elements having a circular cross-section. Such terms are to be understood, in a broader sense of a flange (for example) which extends around the insulator, following the outer profile of the insulator, whatever cross-sectional profile the insulator has.

FIG. 2 shows a section through the collar element 7, the coolant conduit 8 and the insulator element 3, along the plane A-A in FIG. 1. FIG. 2 shows the concentric arrangement of the collar element 7, the coolant conduit 8 and the insulator element 3. It also shows how the coolant channels 14 and 15 (feed and return) which supply the anode cooling circuit can be arranged to pass through the collar element 7, and how connecting channels 17 can be formed within the collar element 7 to connect the coolant conduit 8 to the coolant channels 14 and 15, In this way, both the insulator element 3 and the anode assembly 11, 12, 13 (not shown in FIG. 2) can he cooled with the same coolant supply, connected to the X-ray tube by the same coolant connector 16.

Also shown in FIG. 2 is a flow restriction/regulation element 22, which can be arranged in the conduit in order to balance the flow rate in the shorter flow path between the connecting channels 17, against the flow rate in the longer flow path between the connecting channels 17. The flow restriction/regulation element 22 may be a tap, a valve, or a simple flow-restricting shape, for example, and may be fixed, or variable in size or shape. It can be set such that the cooling rate is as constant as possible around the circumference of the insulator cone 3.

FIG. 2 also indicates discontinuous section line B-B, on which FIG. 3 is based. FIG. 3 shows in sectional view how the coolant conduit 8 can be connected to coolant channel 14 by the connecting channel 17, and how the coolant supply connections 16 can supply both the anode cooling circuit (not shown) via conduit 14, and also the insulator cooling conduit 8. The detail of the coolant channel connection is shown in FIG. 4, which represents an enlarged view of region III of FIG. 3.

FIG. 4 shows the coolant conduit 8 connected via channel 17 to coolant supply channel 14, and thence to external coolant supply connection 16. The coolant conduit is formed in the interface between the collar element 7 and the insulator element 3. It is shown as a recessed channel of rectangular cross-section formed in the material of the collar element 7, and closed by the surface of the insulating element 3, such that the coolant can flow through the conduit while remaining in direct contact with the outer surface 19 of the insulator element 3.

The conduit 8 is shown with a rectangular cross-section and parallel side-walls 18, although it could also be formed with other profiles. In the specific case where the thermal expansion properties of the collar 7 and insulator 3 are well matched, this kind of joint may suffice, since no significant movement would be expected between the collar 7 and insulator 3 as the former heats up and cools down.

However, the collar 7 and the insulator 3 may be made of materials having different thermal-mechanical behaviours, in which case some relative radial movement may be expected between the collar 7 and the insulator 3. In this case, to avoid the build-up of stresses between the collar 7 and the insulator 3, one or both of them can be made of material which is sufficiently elastic to expand or contract as required to allow for the relative radial movement.

Such relative radial movements may alternatively be accommodated by implementing the cooling conduit 8 with separate walls extending between the insulator 3 and the collar 7, the walls being sufficiently elastic to extend or contract radially (relative to the central longitudinal axis of the insulator) to absorb the relative radial movements. An example of such an implementation is shown in FIG. 5. Two ring flanges made from springy sheet metal, for example, are each sealed at a first edge to the outer surface 20 of the insulator 3 and at a second edge to the inner surface of the collar element 7. The first and second edge of each flange 9 may be connected by an inclined portion, such that the two first edges, sealed to the surface 20 of the insulator 3, are further apart than the two second edges, sealed to the collar 7. In this way, the contact area between the coolant and the surface 20 of the insulator 3 can be increased, thereby increasing its cooling efficiency. One or both of the flange ring elements 9 may be sealed to the surface 20 of the insulator 3 using a brazing or soldering process to create brazed or soldered joints indicated by references 21 in FIG. 5. If the insulator 3 is composed of a ceramic material, the surface 20 of the ceramic material can be metalized in order to facilitate this soldering operation. Such a metallization process of the surface 20 of the insulator 3 can also promote heat transfer between the insulator 3 and the coolant in the coolant conduit S.

The vacuum-side flange ring (the left-hand one of the flange rings 9 in FIG. 5) must be secured and sealed to a high-vacuum specification. The atmosphere-side flange-ring, on the other hand requires less stringent sealing if the coolant is substantially at atmospheric pressure. For this reason, it is possible to dispense with the soldering or brazing of the atmosphere-side flange ring to the insulator, and to use the spring force to maintain compression in the seal between the flange ring and the insulator surface.

The flange ring elements 9 can be formed at least in part from a spring material, and may be held in compression between the collar element 7 a Id the insulator element 3. This arrangement has the advantage of giving a more reliable and longer-lasting seal, and providing mechanical support between the collar element and the insulator element.

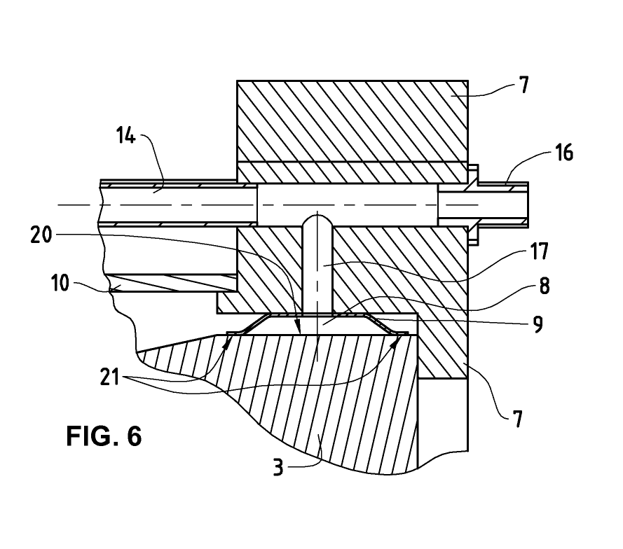

FIG. 6 shows a slightly different arrangement, in which the flange ring elements 9 are constructed as a single piece, for example of spring steel. In this case, boles are provided in the flange piece 9, which coincide with the openings of channels 17, such that coolant can enter and leave the interior space formed between the flange piece 9 and the insulator 3.

1. Device for generating X-rays or an electron beam, the device comprising:
a vacuum enclosure for enclosing one or more electron emitter components in a vacuum,
an insulation element in thermal contact, at a first region of the insulation element, with one or more of the electron emitter components in the vacuum enclosure,
cooling means for cooling insulation element
wherein
the cooling means comprises a coolant conduit for conveying coolant fluid such that the coolant fluid flows in contact with a second region of the insulation element.

2. Device according to claim 1, wherein the coolant conduit comprises a passage formed within the insulation element.

3. Device according to claim 1, wherein the coolant conduit comprises one or more conduit walls,
at least one of the conduit walls is formed by the the second region the insulation element.

4. Device according to claim 3, comprising a collar element for supporting the insulation element at the second region of the insulation element, wherein at least one of the conduit walls extends from the outer surface of the insulation element to the collar element.

5. Device according to claim 4, wherein at least one of the conduit walls is formed by a surface of the collar element.

6. Device according to claim 4, wherein at least one of the conduit walls is formed as a flange ring element extending between the outer surface of the insulation element and the collar element.

7. Device according to claim 6, wherein the insulation element has a substantially circular cross-section at its second region, and wherein the or each flange ring element is deformable in at least a radial direction of the cross-section of the insulation element.

8. Device according to claim 1, wherein at least one of the conduit walls forms a vacuum wall of the vacuum enclosure.

9. Device according to claim 8, wherein the collar element comprises one or more first coolant channels for conveying coolant into and/or out of the coolant conduit.

10. Device according to claim 9, wherein the collar element comprises one or more second coolant channels, the or each second coolant channel being for conveying coolant from an external coolant connection to an anode-cooling fluid circuit of the device, and wherein the or each first coolant channel communicates with one of the one or more second coolant channels such that coolant from the external coolant connection can flow through both the coolant conduit and through the anode-cooling fluid circuit.

11. Device according to claim 1, wherein the coolant conduit comprises one or more flow-regulation or flow-restriction means.

12. Device according to claim 11, wherein at least one of the conduit walls is sealed to the insulation element by a soldered or brazed joint.

13. Device according to claim 12, wherein the or each flange ring element is formed at least in part from a spring material.

14. Device according to claim 13, wherein the or each flange ring element is held in compression against the insulator element.

15. Method of manufacturing a device for generating X-rays or electron beams, the device comprising a substantially longitudinal insulation element and a vacuum enclosure for enclosing an electron emitter assembly in a vacuum, the electron emitter assembly being mounted at a first region of the insulating element, inside the vacuum enclosure.
the method comprising a conduit-forming step, in which a coolant conduit is formed at a second region of the insulating element, outside the vacuum enclosure and/or in a wall of the vacuum enclosure, such that coolant fluid flowing in the coolant conduit can flow in contact with the second region of the insulation element.

16. Method according to claim 15, wherein the conduit-forming step comprises:
a fitting step, in which a first flange ring element is fitted around the insulation element at a first predetermined position along the longitudinal axis of the insulation element in the second region of the insulation element, and
a fixing step, in which the first flange ring element is sealed to the surface of the insulation element at the first predetermined position.

17. Method according to claim 15, in which
the fitting step comprises fitting a second flange ring element around the insulation element at a second predetermined position along the longitudinal axis of the insulation element, the first and second predetermined positions being separated b a flange separation distance,
and in which the fixing step comprises sealing the second flange ring element to the surface of the insulation element at the second predetermined position.

18. Method according to claim 15, comprising a collar lining step. in which a collar element is fitted over the first flange ring element, or the first and second flange ring elements, so as to form a substantially closed fluid conduit running around the insulation element at the second region of the insulation element, such that the walls of the conduit are formed by the surface of the insulation element and:
the first flange ring element; or
the first flange ring element and an inner surface of the collar element; or
the first and second flange ring elements; or
the first and second flange ring elements and the inner surface of the collar element.

19. Method according to claim 16, wherein:
the insulator element comprises a ceramic material,
the method comprises a surface preparation step in which the surface of the ceramic material is metalized at the first predetermined position and/or at the second predetermined position, and
the fixing step comprises soldering or brazing the first flange ring element and/or the second flange ring element to the metalized ceramic material.
